(19) United States
(12) Patent Application Publication
(10) Pub. No.: US 2011/0272458 A1
(43) Pub. Date: Nov. 10, 2011

(54) AUTO-BOTTOM CARTON WITH SELF-ERECTING PARTITION

(75) Inventor: Gregory J. Hardy, North Andover, MA (US)

(73) Assignee: OSRAM SYLVANIA INC., Danvers, MA (US)

(21) Appl. No.: 12/875,813

(22) Filed: Sep. 3, 2010

Related U.S. Application Data
(60) Provisional application No. 61/343,779, filed on May 4, 2010.

(51) Int. Cl. B65D 25/04; B31B 5/26

(52) U.S. Cl. 229/120.17; 493/312

(57) ABSTRACT

A carton (101) including at least one self-erecting partition (146, 156) disposed in an auto-bottom carton defining a plurality of compartments (306, 308) therein. The auto-bottom carton including at least one self-erecting partition includes a plurality of panels (102, 104, 106, 108), a bottom (304), an optional cover (170), and at least one partition (146, 156) that extends in an interior portion (302) of the carton, which interior portion is defined by the panels (102, 104, 106, 108) and bottom (304). An extension (144, 154) connects the partition (146, 156) to a respective bottom flap (120, 128, 140, 150). The carton (101) may be knocked down, shipped flat, and squared up, i.e., erected, prior to filling. Upon erecting the carton (101) the at least one partition (146, 156) positions itself in the interior (302) of the carton (101) so as to form two or more compartments (306, 308) in the carton interior (302).

### CROSS-REFERENCE TO RELATED APPLICATIONS

The present application claims the benefit of the filing date of U.S. Provisional Application No. 61/343,779, filed on May 4, 2010, the teachings of which are incorporated herein by reference.

### TECHNICAL FIELD

The present disclosure relates to auto-bottom cartons with a self-erecting partition.

### BACKGROUND

The use of cartons, including cartons having partitions therein, is common in a number of industries. For example, in lighting applications a number of light bulbs may be positioned in a single carton. Partitions have been provided in cartons to prevent the bulbs from breaking as well as to maintain the position of the bulbs when one or more are removed from the carton.

One example of a partitioned carton is illustrated in U.S. Pat. No. 4,345,711. The carton may be assembled by folding the blank at a number of fold lines as illustrated in FIG. 2 of the patent. As stated therein at Col. 3, lines 58-62 “[a]dhesive will be applied to the areas indicated at 98 and 100 formed on the flaps 50 and 52 between the fold lines 62 and 86 and 64 and 88 respectively, or in the corresponding areas in the adjacent end bottom flaps 48 and 52.” Further, the patent recites at Col. 4, lines 42-50 that “[t]he squaring up movement moves the projection 80 into the aperture 80 and forces the left hand edge of the projection 82 in FIG. 5 to the left hand edge of the aperture 80. After the carton has been squared the projection 82 rests against the inner face of the flap 50 and the abutment edge 79 is urged against the curved wall 84 of the aperture via the inherent tendency of the carton to assume the knock-down position.” Other known examples of cartons include those disclosed in U.S. Pat. No. 4,530,460; 4,179,061; 4,095,735; 6,557,749; 4,509,640; and 2,883,098.

### BRIEF DESCRIPTION OF THE DRAWINGS

Reference should be made to the following detailed description which should be read in conjunction with the following figures, wherein like numerals represent like parts:

FIG. 1 illustrates an embodiment of a carton blank consistent with the present disclosure;

FIG. 2 illustrates the carton blank of FIG. 1, calling out various dimensions;

FIG. 3 illustrates a variation of the carton blank of FIG. 1, wherein the extension length is shortened;

FIG. 4 illustrates a variation of the carton blank of FIG. 1, wherein the closure flap, side flaps and fixation lap are not included;

FIG. 5 illustrates a variation of the carton blank of FIG. 1, wherein the fixation lap is positioned on a side panel;

FIG. 6 illustrates a variation of the carton blank of FIG. 1, wherein the partitions include a foot extending therefrom and the fixation flap extends from a side panel;

FIG. 7 illustrates a variation of the carton blank of FIG. 1, wherein the partitions include a foot extending therefrom and the fixation flap extends from a front panel;

FIG. 8 illustrates a variation of the carton blank of FIG. 1, wherein the front bottom flap is coupled to the first side bottom flap and the back bottom flap is coupled to the second side bottom flap;

FIG. 9 illustrates a variation of the carton blank of FIG. 1, wherein the blank includes a single partition and an optional partition stabilizer;

FIG. 10 illustrates an embodiment of a partially erected carton blank of FIG. 1;

FIG. 11 illustrates a carton folded flat or knocked-down flat;

FIG. 12 illustrates a top perspective view of the erected carton of FIG. 1;

FIG. 13 illustrates another top perspective view of the erected carton of FIG. 1;

FIG. 14 illustrates a bottom perspective view of the erected carton of FIG. 1; and

FIG. 15 illustrates a further top perspective view of another embodiment of an erected carton.

### DETAILED DESCRIPTION

In general, a carton consistent with the present disclosure includes at least one self-erecting partition disposed in a carton defining a plurality of compartments therein. The carton including at least one self-erecting partition may generally include a plurality of panels, a bottom, an optional cover, and at least one partition that may extend in an interior portion of the carton, which may be defined by the panels and bottom. The carton may be knocked down, shipped flat and squared up, i.e., erected, prior to filling. Upon erecting the carton, the at least one partition is positioned in the interior of the carton so as to form two or more compartments in the carton interior. In some embodiments, the carton may be an auto-bottom carton, wherein the bottom of the carton may be formed without tape or other fasteners.

Sheet stock for forming the carton blanks may include paperboard such as folding card material or corrugated fiberboard of varying densities; metals or metal alloys; or polymeric materials including polyolefin such as polyethylene of varying densities or polypropylene, acrylics, polyesters, etc., formed into sheet, foam or fabric. The sheet stock may be 1/64 inches in thickness or greater, such as 1/32 inches, 1/16 inches, ⅛ inches, ¼ inches etc. The sheet stock may be coated or printed prior to or after cutting. The blanks may be formed by cutting sheet stock using any of a number of processes including, but not limited to die cutting including flat bed die cutting or rotary die cutting, laser cutting, water jet cutting or hand cutting. The blanks may also be formed by molding the blanks using plastics processing techniques such as injection molding or other forms of thermoplastic forming. During the cutting or forming process, various creases may be formed in the sheet stock that may later be used in erecting the carton.

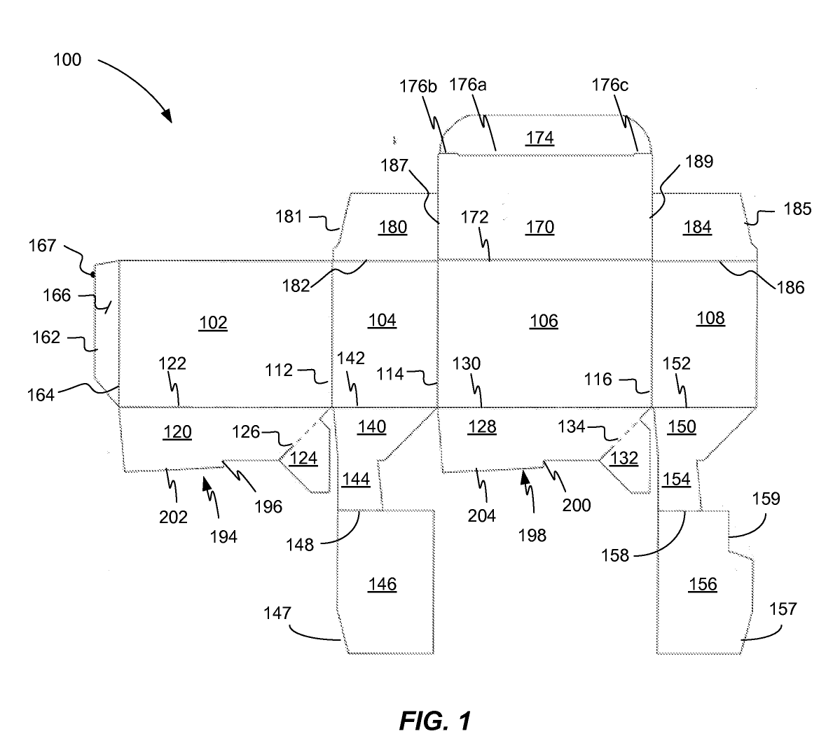

FIGS. 1 through 9 illustrate various embodiments of carton blanks consistent with the present disclosure and are approximately to scale, taken from manufacturing drawings. As shown in FIG. 1, an embodiment of the carton blank 100 includes a plurality of panels including a front panel 102, a first side panel 104, a back panel 106 and a second side panel 108. Upon folding of the carton blank 100, the panels 102, 104, 106, 108 are configured to form a sleeve. Thus, the illustrated carton blank 100 may include four wall panels; however, in other embodiments six panels or eight panels may be provided, etc. The panels 102, 104, 106, 108 may be joined at first crease 112, second crease 114, and third crease 116, positioned between the panels. Creases may be understood as deformations in the carton blank, such as score lines, folds, perforations or combinations thereof. As illustrated, the creases 112, 114, 116 are substantially parallel.

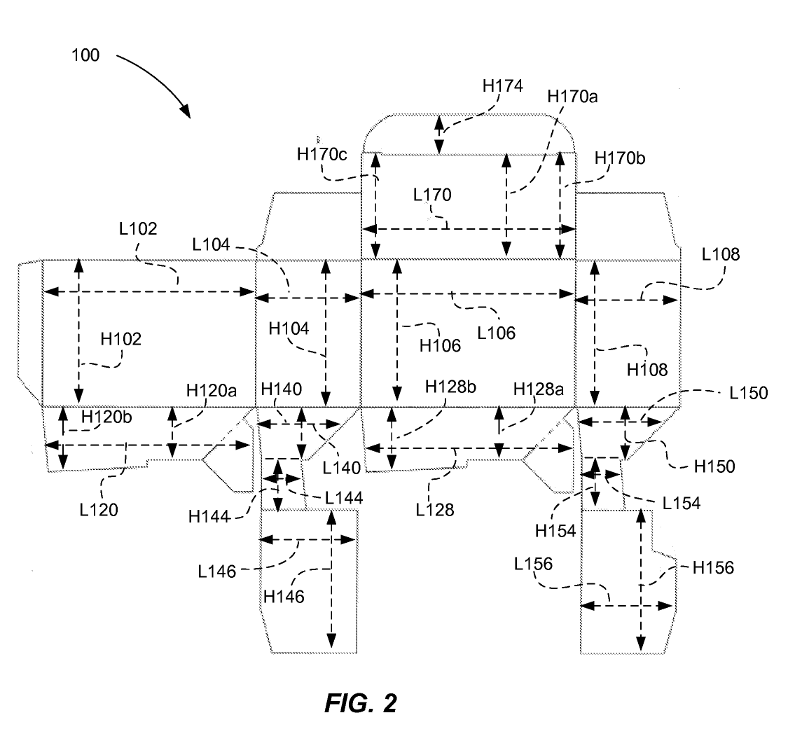

Referring to FIG. 2, each panel has a length L102, L104, L106, L108 and a height H102, H104, H106, H108. The lengths of the panels L102, L104, L106, L108 may be equal or may be of different lengths. In one embodiment, the length of each panel L102, L104, L106, L108 is selected from the range of 0.5 inches or greater, including all values at 1/64 inch increments such as 3 inches, 4 inches, 5 inches, 10 inches, etc. The height of each panel H102, H104, H106, H108 is selected from the range of 0.25 inches or greater, including all values at 1/64 inch increments such as 1 inch, 2 inches, 3 inches, 5 inches, etc.

In one embodiment, as illustrated in FIG. 2, the length of the front panel L102 and the length of the back panel L106 may be equal. Further, the length of the first side panel L104 and the length of the second side panel L108 may be equal. In some examples, the length of the front panel L102 and the length of the back panel L106 may be greater than the length of the first side panel L104 and second side panel L108. In other examples the length of the front panel L102 and the length of the back panel L106 may be less than the length of the first side panel L104 and second side panel L108. In some examples, the length of the panels L102, L104, L106, L108 may all be equal and the carton may be square. Further, while the height of the panels H102, H104, H106, H108 are illustrated as being the same, some panels may be provided that exhibit a greater height than others. For example, in some embodiments the height of the back panel H106 may be greater than that of the remaining panels H102, H104, H108.

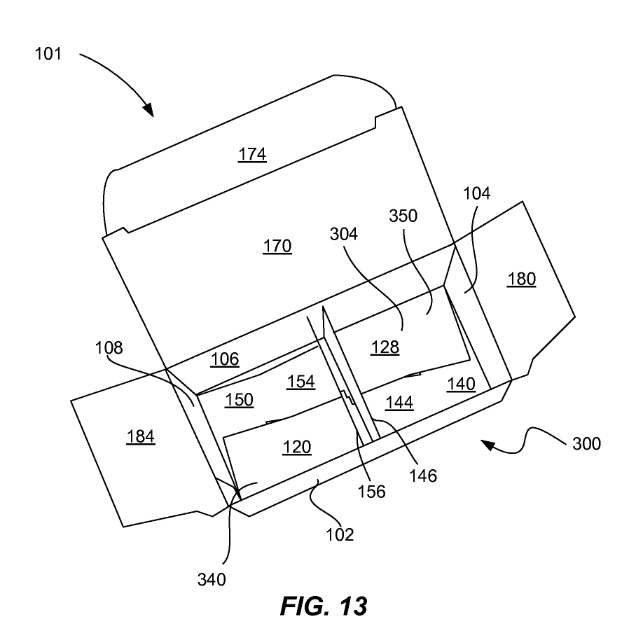

Referring again to FIG. 1, a number of bottom flaps 120, 140, 128, 150 are joined to the panels 102, 104, 106, 108 at a number of associated creases 122, 142, 130, 152, respectively. As illustrated in FIG. 1, a front bottom flap 120 is joined to the front panel 102 at a first bottom flap crease 122, a first side bottom flap 140 is joined to the first side panel 104 at a first side bottom flap crease 142, a back bottom flap 128 is joined to the back panel 106 at a back bottom crease 130, and a second side bottom flap 150 is joined to the second side panel 108 at second side bottom flap crease 152. In other embodiments, bottom flaps 120, 140, 128, 150 may be provided on less than all of the panels 102, 104, 106, 108. Upon erecting the carton, the bottom flaps 120, 140, 128, 150 are configured to form a bottom 304. The creases 122, 142, 130, 152 joining the bottom flaps 120, 140, 128, 150, respectively may be joined together to form an otherwise continuous crease or may be independent creases formed in the carton blank 100. Upon erecting of the carton 101 as illustrated in FIGS. 13 through 16, the panels 102, 104, 106, 108 and flaps 122, 142, 130, 152 of FIG. 2 may be folded along the associated creases 122, 130, 142, 152 in either direction, towards or away from the viewer.

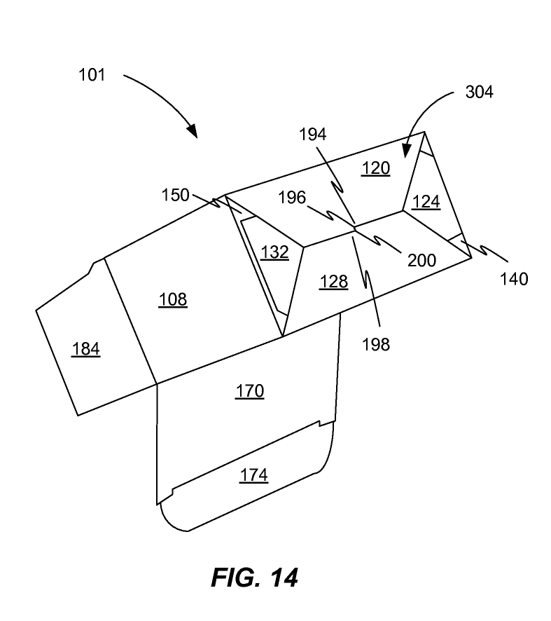

One or more of the bottom flaps 120, 140, 128, 150 may include a fixation tab 124, 132. As illustrated in FIG. 1, a first fixation tab 124 may be joined to the front bottom flap 120 and a second fixation tab 132 may be joined to the back bottom flap 128. The fixation tabs 124, 132 may be joined to the bottom flaps 120, 140, 128, 150 at a tab crease, such as first fixation tab crease 126 and a second fixation tab crease 134 illustrated in FIG. 1. The fixation tabs 124, 132, are configured to be affixed to the adjacent bottom flaps 140, 150, respectively, in an overlapping manner when the carton 101 is assembled, such as illustrated in FIGS. 13 through 16. When assembled, the fixation tabs 124, 132 are positioned underneath the bottom flaps 140, 150, such that they are positioned on the exterior of the carton 101 (see FIG. 14).

At least two of the bottom flaps, such as the front bottom flap 120 and back bottom flap 128 may also include a first locking feature 194 and a second locking feature 198, respectively. The locking features 194, 198 may be configured to mate allowing the front bottom flap 120 and back bottom flap 128 to partially overlap each other. The first locking feature 194 may include a first notch 196 defined in front bottom flap 120 by a first portion of the flap 120 that exhibits a first height H120a (see FIG. 2) that is shorter than a second portion of the flap 120 exhibiting a second height H120b (see FIG. 2). Similarly, the second locking feature 198 may include a second notch 200 defined in back bottom flaps 128 by a first portion of the flap 128 that exhibits a height H128a (see FIG. 2) that is shorter than the height H128b (see FIG. 2) exhibited by a second portion of the flap 128. In one embodiment, the notches 196, 200 may be positioned at or near the center of the bottom flaps 120, 128 along edges 202, 204 of the bottom flaps 120, 128. In another embodiment, the locking features may be included in opposing side flaps 140, 150. In a further embodiment, the length L120, L140, L128, L150 of each of the bottom flaps may individually be as long as or shorter than the respective length of the panels L102, L104, L106, L108 to which they are associated. Length is understood to be generally parallel to creases 122, 132, 142, 152 and height is understood to be generally perpendicular to the length. In one embodiment, the height H120a of the first flap portion and the height H128a of the second flap portion are selected from the range of 0.25 inches or greater, including all values at 1/64 inch increments, such as 2 inches, 3 inches, 5 inches, etc.

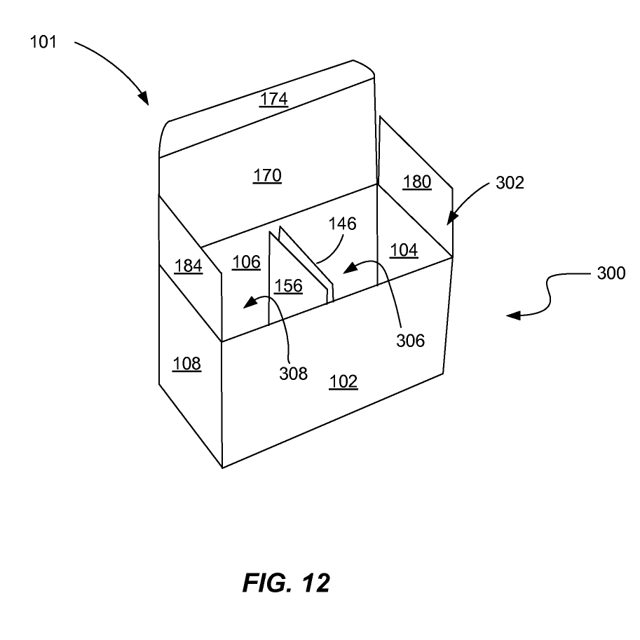

Referring again to FIG. 1, the carton blank 100 includes partitions 146, 156, which are joined to the bottom flaps 120, 140, 128, 150 via extensions, which are discussed further herein. A partition may divide an interior portion of a carton into a plurality of compartments 306, 308 (as illustrated in FIG. 12). As illustrated in FIG. 1, a first partition 146 is joined at crease 148 to a first extension 144, which in turn is joined to first side bottom panel 140, and a second partition 156 is joined at crease 158 to a second extension 154, which in turn is joined to second side bottom panel 150. In other embodiments, a single one of either partitions 146, 156 may be provided, described further below, and in further embodiments, additional partitions (more than two partitions) may be provided. The partitions 146, 156 may also include partition clearance cutouts 147, 157 configured to accommodate a closure flap tuck, described further herein.

The extensions 144, 154 generally exhibit an extension length (L144, L154) that is less than a bottom flap length (L140, L150) of the bottom flaps 140, 150 to which the extensions 144, 154 are attached, wherein the extension length (L144, L154) is less than the bottom flap length (L140, L150). For example, where the extensions 144, 154 join the bottom flaps 140, 150, the extensions 144, 154 exhibit a length that is at least 1/64 inches smaller than the length of the bottom flap 140, 150 and may be 5/32 inches smaller, 3/16 inches smaller, etc. Thus, the transition between the extension length and the bottom flap length may be abrupt. Further, each of the partitions 146, 156 generally exhibits a partition length L146, L156 that is greater than the length of the associated extensions L144, L154. For example, where the extensions 144, 154 join the partitions 146, 156, the extensions exhibit a length L144, L154 that is at least 1/64 inches smaller than the length of the partitions L146, L156, such as 0.5 inches, 1 inch, including all values at 1/64 inch increments, etc. Again, the transition between the extension length and the partition length may be abrupt. Referring to FIG. 2, the lengths of the bottom flaps L140, L150 are the same or different. In addition, the lengths of the extensions L144, L154 may be the same or different. Further, the lengths of the partitions L146, L156 may be the same or different. When erected, the extensions 144, 154 and partitions 146, 156 may overlie the bottom 304 of the carton 101, disposed on the interior 302 of the bottom 304. Equally true is that the extensions 144, 154 overlie a bottom panel 120, 128 adjacent to the bottom panel 140, 150 from which the extension extends. Further, both surfaces, i.e., the opposing surfaces, of the extensions 144, 154 lie within the interior 302 of the erected carton bottom 304, or internal of the boundary defined by bottom 304. The extensions 144, 154 may therefore form a second ply at portions of the bottom 304, which may reinforce the bottom 304 of the carton 101.

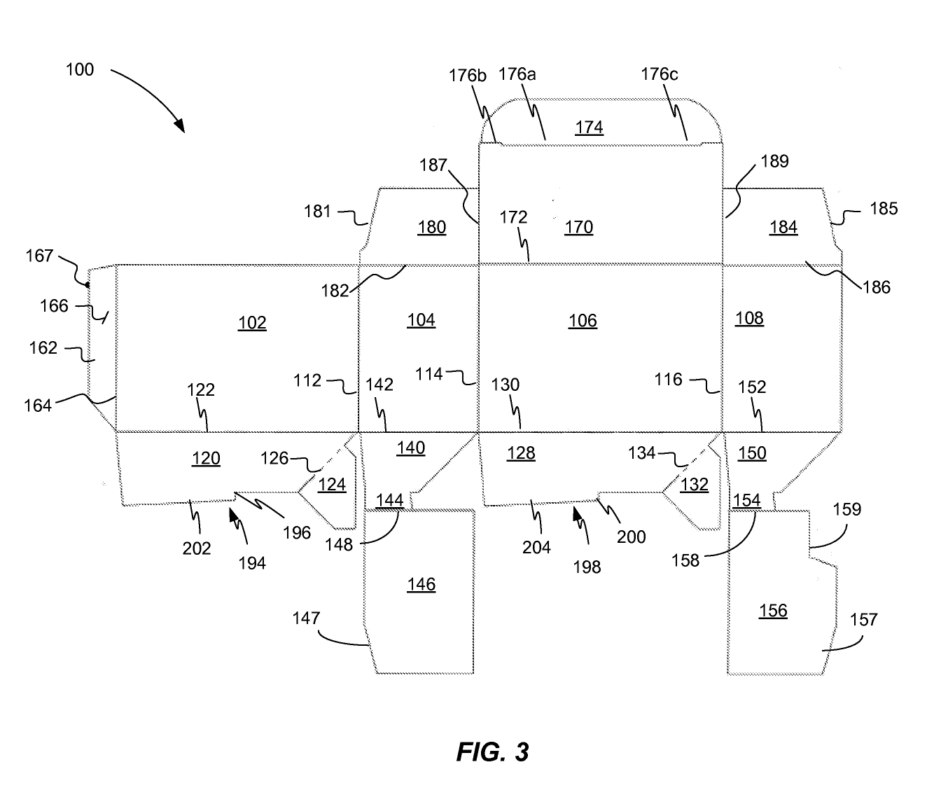

The height of the extensions H144, H154 may be configured such that the positioning of the partitions 146, 156 within the carton may be altered. For example, the height of the extensions H144, H154 may be configured such that when more than one partition 146, 156 (see FIG. 1) is present, the partitions 146, 156 meet. In some embodiments, the partitions 146, 156 may meet where the partitions have side surfaces in opposed facing relationship or are in contact with each other as shown, for example, in FIG. 12, at or near the center of the carton, along the length of the front panel L102 or back panel L106 defining substantially equal compartments within the interior. In other embodiments, the partitions 146, 156 may meet at a position away from the center of the front or back panel length L102, L106 defining unequal compartments within the interior. Further, the extensions 144, 154 may be sized or the extension creases 148, 158 formed such that the partitions do not meet, forming additional compartments within the interior, for example, by making one or more extensions 144, 154 shorter. FIG. 3 illustrates such an embodiment where the height of the extensions 144, 154 is reduced to form three compartments within the carton when the carton blank 100 is erected.

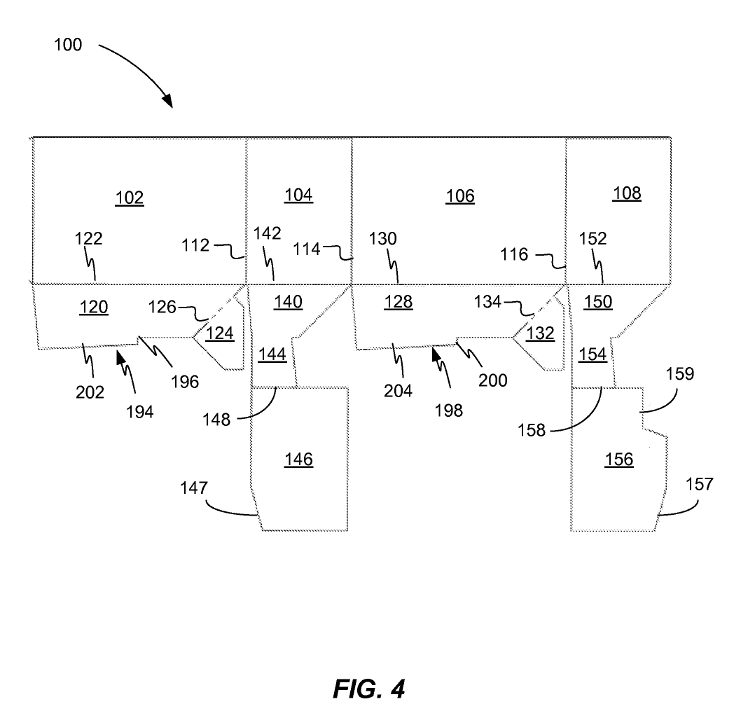

The carton blank 100 may optionally include at least one fixation lap 162 joined to a panel 102, 104, 106, 108. As illustrated in FIG. 1, the fixation lap 162 is joined to the front panel 102 via fixation crease 164. A fixation lap 162 on the length side (such as front panel 102) may be suitable for cartons having a relatively higher load capacity. A carton formed from this carton blank may be useful, for example, in packaging PAR20 lamps, available from OSRAM SYLVANIA of Danvers, Ma. In other embodiments, the fixation lap 162 may be joined to other panels, such as second side panel 108 as described further herein. The fixation lap 162 is illustrated as extending at least partially along the height of the panel 102 to which it is joined. However, in other embodiments, the fixation lap 162 may extend a portion of the length of panel 102 or may be broken into portions wherein multiple fixation laps may be present. FIG. 4 illustrates an example that does not include a fixation lap. In such an embodiment, the panels 102, 108 may be coupled together by tape or mechanical fasteners such as staples, brads, string, etc.

Again referring to FIG. 1, the carton blank 100 includes a closure flap 170 joined to the back panel 106 at closure crease 172. The carton flap 170 may be configured to enclose the carton interior once the carton has been erected. The closure flap 170 may include a closure flap tuck 174 joined to the closure flap 170 at tuck crease 176. In other embodiments, the closure flap 170 may be coupled to one or more of the front panel 102 or side panels 104, 108 by tape, glue, ultrasonic welding or by mechanical fasteners such as clips, strings, etc. As alluded to above, the partitions 146, 156 include first and second partition clearance cutouts 147, 157, which are configured to prevent interference between the closure tuck flap 174 and the partitions 146, 156 when the tuck flap 174 is inserted into the carton once the carton blank 100 is erected. As illustrated, the tuck crease 176 includes a scored portion 176a as well as at least one cut portion 176b, 176c. However, the combination of the scored portion 176a and the cut portions 176b, 176c are optional. Further, with reference to FIG. 2, height of the closure flap H170a along the scored portion is less than the height of the closure flap H170b, H170c along the cut portion. Further, the length of the closure flap L170 may be less than the length of the back panel L106. The height of the closure flap H170a, H170b, H170c is configured based on the length of side panels L104, L108.

Additional top side flaps may be provided. As illustrated in FIG. 1, a first top side flap 180 is joined to the first side panel 104 at first top side flap crease 182 and a second top side flap 184 is joined to the second top side panel 108 at second top side flap crease 186. The top side flaps 180, 184 may be separated from the closure flap 170 via cut lines 187, 189. The first and second top side flaps 180, 184 may include top flap clearance cutouts 181, 183 configured to accommodate the closure flap tuck 174 preventing interference between the closure flap tuck 174 and the top side flaps 180, 184 when the closure flap tuck 174 is inserted into the carton when the carton blank 100 is erected. The closure flap 170 and top side flaps 180, 184 are optional. FIG. 4 illustrates an embodiment wherein these flaps are not included.

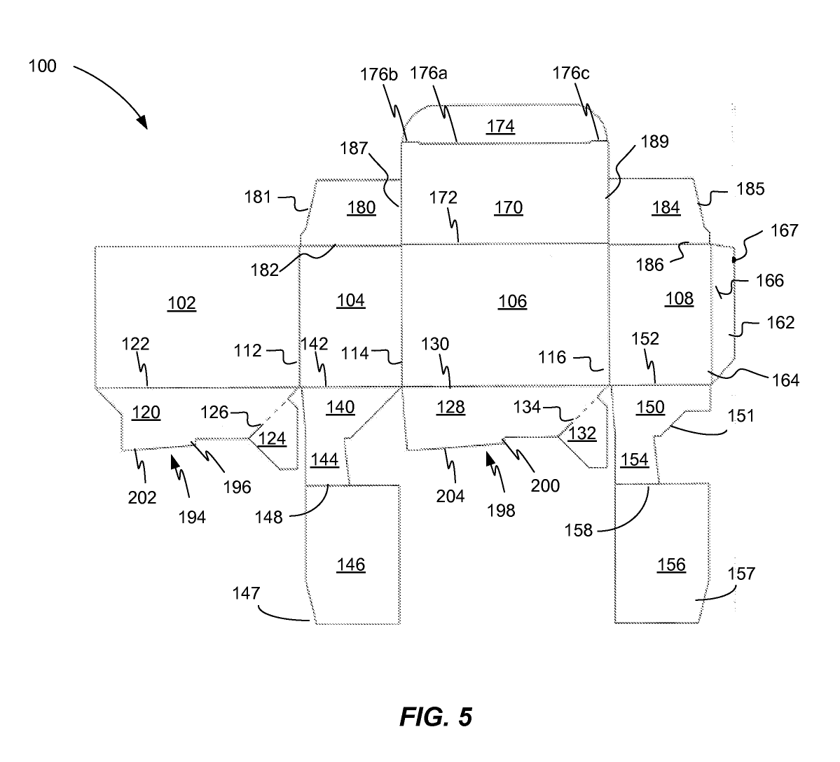

FIG. 5 illustrates a further embodiment of a carton blank 100 wherein the fixation lap 162 is joined to a side panel 108 at fixation crease 164. In addition, the second side bottom flap 150 includes a second side bottom flap cutaway portion 151, which adds more material near the fixation lap 162. The additional material enables the partition to be stronger, so that heavier objects can be accommodated. Furthermore, the front side bottom flap 120 includes a clearance cutout 121. The front side bottom flap clearance cutout 121 prevents interference between the front side bottom flap 120 and the fixation lap 162 during erection of the carton. While such a cutout 121 may weaken this portion of the carton bottom 304, the additional material provided at the cutaway portion 151 of the second size bottom flap 150 stabilizes or reduces the effects of such losses.

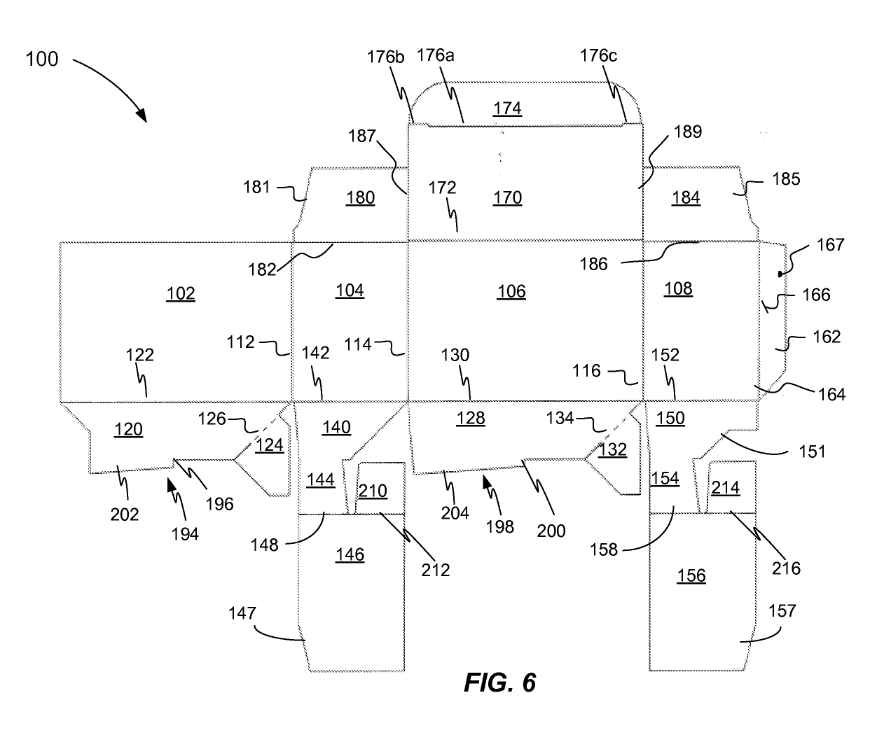

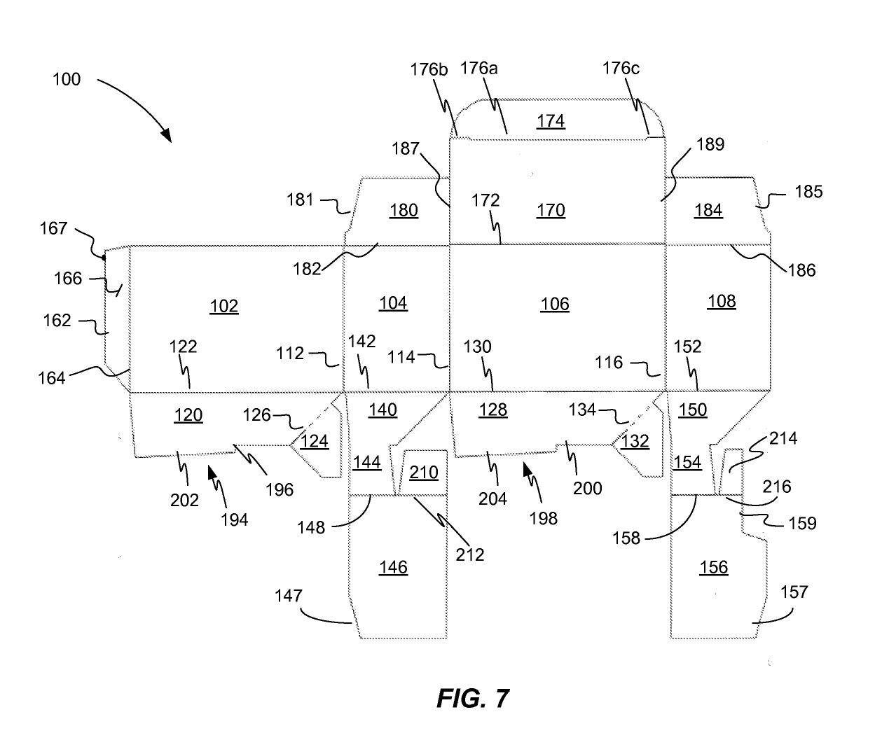

FIGS. 6 and 7 illustrate further embodiments wherein the partitions 146, 156 may each include a foot 210, 214. The foot 210, 214 stabilizes the associated partition 146, 156. For example, FIG. 6 illustrates an example where the fixation lap 162 is joined to second side panel 108 and the partitions 146, 156, each include a foot 210, 214. The first foot 210 is joined to the first partition 146 at first foot crease 212 and the second foot 214 is joined to the second partition 156 at second foot crease 216. FIG. 7 illustrates an example where the fixation lap 162 is joined to front panel 102 and the first foot 210 on the first partition 146 is smaller than the second foot 214 on the second partition 156. Furthermore, as illustrated in FIG. 7, an additional cutout 159 is provided on the second partition 156. The additional cutout 159 may prevent interference between the fixation lap 162 and the second partition 156 as well as the second foot 214 during assembly.

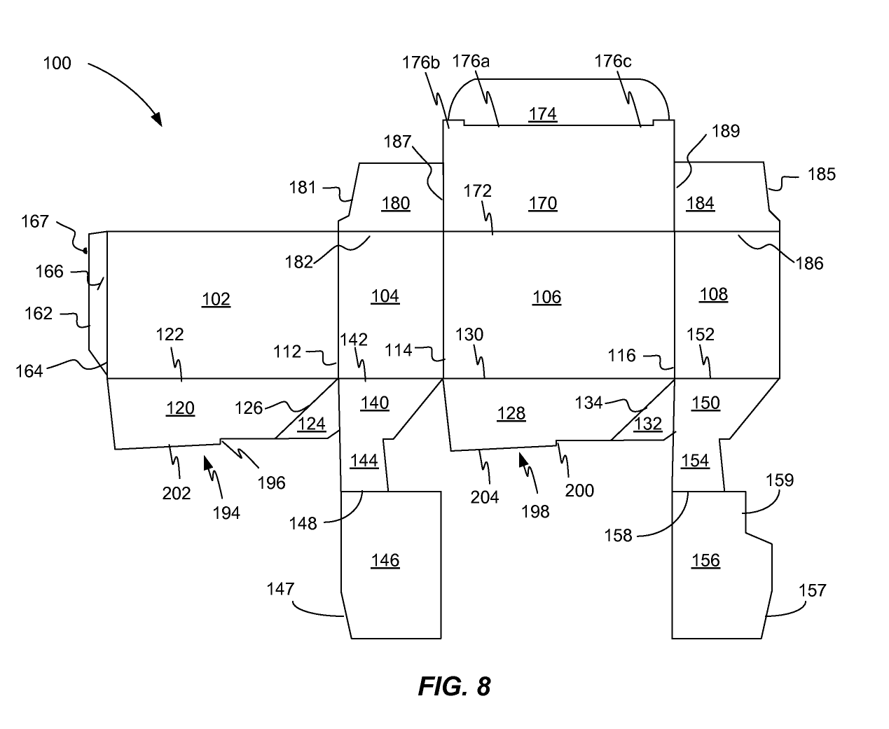

FIG. 8 illustrates yet a further embodiment of a carton blank 100, wherein the first fixation tab 124 couples the front bottom flap 120 to the first side bottom flap 140 and the second fixation tab 132 couples the back bottom flap 128 to the second side bottom flap 150. The first fixation tab 124 may be joined to the front bottom flap 120 at first fixation tab crease 126 and at third fixation tab crease 127. The second fixation tab 132 may be joined to the back bottom flap 128 at second fixation tab crease 134 and at fourth fixation tab crease 135. This arrangement also provides, by way of example, the automatic bottom aspect upon squaring the carton.

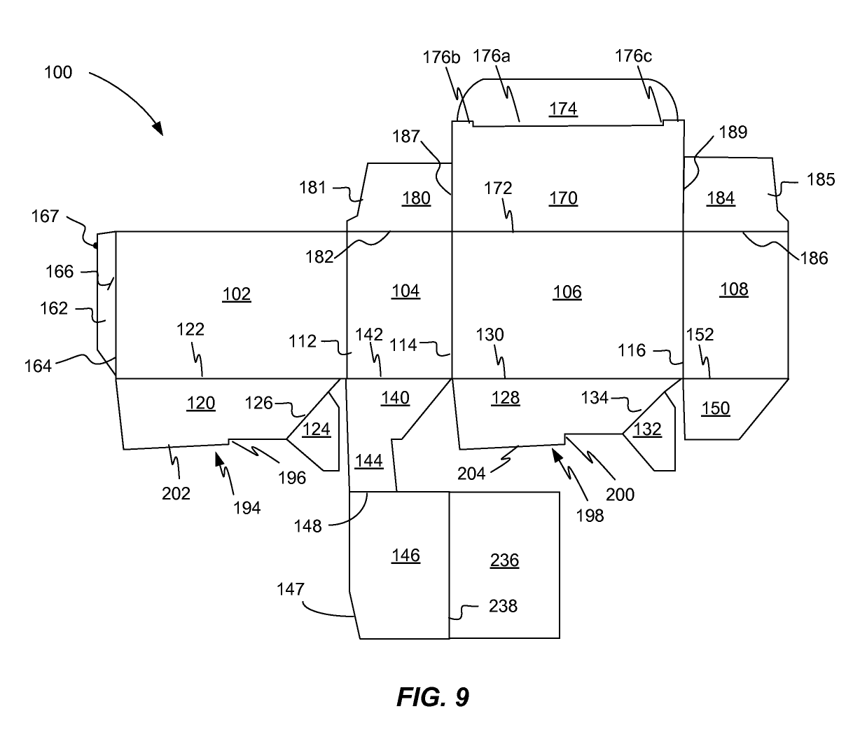

FIG. 9 illustrates an embodiment of a carton blank 100, wherein a single partition 146 is provided. This embodiment also illustrates the inclusion of an optional partition stabilizer 236, joined to the partition 146 at partition stabilizer crease 238. The partition stabilizer 238 may be configured to rest again the opposing panel 108 to the panel 104 which the partition 146 is indirectly affixed to. Partition stabilizers may be present on each partition when more than one partition is present as well.

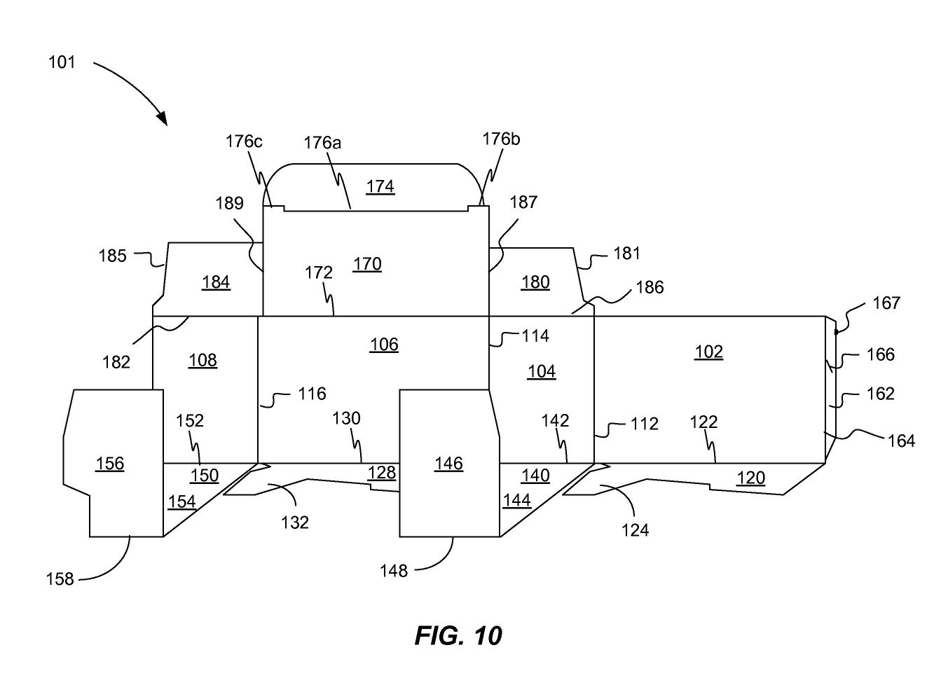

In one embodiment, the knock-down carton may be formed from a carton blank 100 by folding the carton along the partition creases 148, 158 as illustrated in FIG. 10, which positions the partitions 146, 156 in the carton interior once the carton has been erected. The bottom flaps 120, 140, 128, 150 may be folded along creases 122, 142, 130, 152 forming the bottom 304 of the carton. The plurality of panels 102, 104, 106, 108 may be folded along creases 112, 114, and 116 drawing the panels together and forming a sleeve. Folding may be performed in either direction, or the direction of folding may be dictated by the application of surface coatings or graphics on the carton blank.

Two or more adjacent bottom flaps (120, 140, 128, 150) are coupled together. For example, the front bottom flap 120 and the first side bottom flap 140 may be coupled together. One embodiment of such coupling is shown in FIG. 13. Alternatively, in another embodiment, the front bottom flap 120 and the first side bottom flap 140 may be coupled together by a flexible joint, such as by taping the flaps 120, 140 together. In another embodiment, a first fixation tab 124 is joined to the front bottom flap 120 at first fixation tab crease 126. The first fixation tab 124 may then overlap the first side bottom flap 140 and may be affixed to the first side bottom flap 140 via adhesive, mechanical fasteners or welding the two portions together. The first fixation tab 124 may be affixed on either side of the bottom flap, provided that upon erecting the carton 101 the fixation tab 124 lies on the exterior of the carton 101 over the first side bottom flap 140. A portion of the first side bottom flap 140 is, therefore, also located on the interior 302 of the carton 101.

Similarly, the back bottom flap 128 and the second side bottom flap 150 may be coupled together. One embodiment of such coupling is shown in FIG. 14. Alternatively, in another embodiment, the back bottom flap 128 and the second side bottom flap 150 may be coupled together by a flexible joint, such as by taping the flaps 128, 150 together. In another embodiment, a second fixation tab 132 may be joined to the back bottom flap 128 at a second fixation tab crease 134. The second fixation tab 132 may then overlap the second side bottom flap 150 and may be affixed to the second side bottom flap 150 via adhesive, mechanical fasteners, or welding. The second fixation tab 132 may be affixed on either side of the bottom flap, provided that upon erecting the carton 101 the second fixation tab 132 lies on the exterior of the carton 101 over the first side bottom flap 150. A portion of the second side bottom flap 150 is, therefore, also located on the interior 302 of the carton 101.

Alternatively, as illustrated in FIG. 8, the front bottom flap 120 and back bottom flap 128 are coupled to the first and second side bottom flaps 140, 150 via the first fixation tab 124 and second fixation tab 132 respectively, the flaps may be creased along creases 126, 127 and 134, 135 in a manner allowing for the flaps to be collapsed to form a bottom.

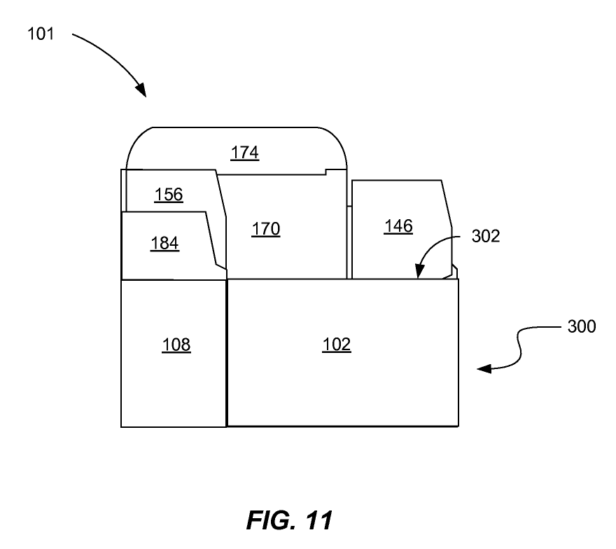

In one embodiment, an adhesive may be applied to fixation lap 162 on either first surface 166 or second surface 167 (shown in FIG. 1) either prior to folding the blank 100 or just prior to folding the fixation lap 162 and the fixation lap 162 may be folded at crease 164 and adhered to the adjacent panel, e.g., second side panel 108. Depending on the surface 166, 167 to which the adhesive is applied, the fixation lap 162 may be tucked within the sleeve 300 (as illustrated in FIG. 11) or positioned over the sleeve 300. The adhesive may include, for example, hot melt, water based, radiation cured or pressure sensitive adhesives. As alluded to above, other chemical or mechanical mechanisms of fixing the panels to form the sleeve may be contemplated. For example, adhesive tape, staples, grommets, or other fasteners may be utilized to join the panels together with or without the use of the fixation lap 162. In addition, where thermoplastic sheet stock is contemplated, fusion bonding, ultrasonic welding, or RF (radio frequency) welding may be utilized.

After the blank is glued along the fixation lap or otherwise formed into a sleeve, the blank forms a collapsible bulk carton that may be shipped in a folded-flat (also called knocked-down-flat or “KDF”) condition. FIG. 11 illustrates an embodiment of the carton 101 folded flat. In this figure, the sleeve 300 is formed and the partitions 146, 156 are positioned in the interior 302 of the carton 101. The one or more partitions 146, 156 bend at associated creases 148, 158 (not illustrated) bend when the carton 101 is squared-up.

FIGS. 12 through 15 illustrate an embodiment of the carton 101, squared-up or erected. Upon squaring-up the carton 101, the bottom flaps 120, 140, 128, 150 (not illustrated) may be drawn down, pulling the partitions 146, 156 into at least a partially erected or a fully erected state as illustrated in FIG. 12. A plurality of compartments 306 and 308 are formed within the interior 302 of the carton 101. In one embodiment, as illustrated in FIG. 13, upon squaring the carton 101, a distal portion 340 of the front bottom flap 120 overlies a portion of the second side bottom flap 150 and a distal portion 350 of the back bottom flap 128 overlies a portion of the first side bottom flap 140. Furthermore, a portion of the second side bottom flap 150 and the second extension 154 overlies a portion of the back bottom flap 128 (the overlapped portion not illustrated) and a portion of the first side bottom flap 140 and first extension 144 overlies a portion of the front bottom flap 120 (the overlapped portion not illustrated). The overall height of the bottom flap is accommodated by the reduced length (“width”) of the extension.

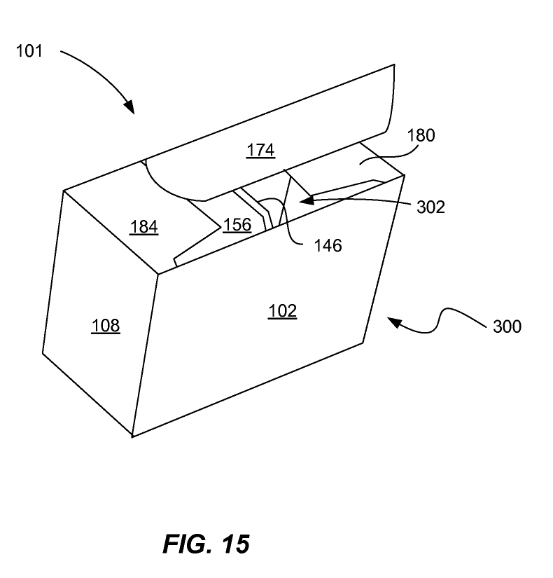

Once the carton 101 has been erected, the locking features 194, 198 may be engaged as illustrated in FIG. 14 and the bottom 304 of a carton 101 may be formed. That is the first notch 196 may engage second notch 200 preventing the carton 101 from folding flat. Other mechanisms of maintaining the carton in an erected position may be utilized as well, including adhesives, mechanical fasteners or welds. When present, the closure flap 170 and top side flaps 180, 184 may be folded down to enclose the interior 302 of the carton 101 as illustrated in FIG. 15.

The carton may be squared by opening into an erected condition by one person manually at a point of use, such as adjacent an assembly line. The bottom does not have to be folded such as by means of a tab by the operator, thus eliminating a processing step. Further, the one or more partitions need not be glued or otherwise affixed upon squaring the carton. The manner in which each blank is glued and then erected into a carton is evident from the depictions to a person of ordinary skill in the packaging arts.

Although the carton could be erected by a machine or robot, it is suitable for simple, quick manual assembly by a worker along a production line, which allows the worker to maintain pace with assembly equipment speed. Due to the one or more partitions, the internal volume is divided into a plurality of compartments, such as at least two compartments. The worker can take two loose lamps off the line and pack them while quickly erecting more cartons from a supply of folded flat packs. This enables flexible manufacture of smaller quantity or niche production and packaging of products without the need, effort and expense of tooling automated pack equipment. The blanks can be printed on the outside with suitable product information and codes so that the erected cartons are suitable for point-of-retail sale use as a so-called SKU (Stock Keeping Unit). The carton may hold bulk merchandise such as a self-supporting object, but could also be used to hold any solid or liquid materials that will not unduly sift or flow out through any cracks in the bottom. The erected carton can be over-wrapped in a foil or film. An item that has been separately sub-packaged can also be placed in one of the compartments. The carton with one or more partitions could also hold a single item, such as a single eyeglass frame, if the partitions were made of suitably low height to support the nose bridge, bracing the eyeglass frame against unwanted movement.

It is understood the dimensions of the blank and, thus the carton, are determined by the object to be held, and any indicated dimensions being non-limiting, exemplary only. The blank is made from a suitable thickness of paperboard, corrugated cardboard or plastic. Each partition is formed from panels that depend from panels preferably forming the “width” sides of the carton. The one or more partitions in the erected carton are perpendicular to the bottom. The one or more partitions are approximately the same height as the width panels. The one or more partitions could be made lower in height than the width panels. The one or more partitions could be made slightly greater in height than the width panels, for example, for use as a carrying grip, which can be further facilitated by a holding aperture punched or otherwise formed into the distal portions (or “upper” portions when the carton is erect) of the partition. Further, through design of the placement of the fixation lap and size of panels forming the respective auto-bottom and one or more self-erecting partitions, appropriate trade-offs can be made as to material allocation to selectively strengthen the auto-bottom or the partitions.

The carton as described has four wall panels connected along corner folds, which can be arbitrarily named as the front, rear and ends or sides. These terms and other terms that might denote a direction (top, bottom, up, down, etc.) may be used for convenience in the description while referring to the disclosure as shown in the drawings. In addition, the figures are approximately to scale. The disclosure is also applicable to similarly constructed cartons in other orientations, or wherein the “front” is arguably an end or is smaller than the “end” and so forth. The disclosure embodiments are also applicable to carton structures with other than four rectilinear walls, such as other polygonal arrangements including four or more walls, wherein at least one wall panel is arranged to become displaced due to erection of the carton, and to bear against a part of another panel or similar structure, for reinforcing, stabilizing or aligning the walls of a carton.

An aspect of the present disclosure relates to a carton including a front panel, a pair of opposing side panels, and a back panel opposing the front panel, wherein the front panel, the side panels and the back panel form a sleeve, and the sleeve defines an interior. The carton includes a front bottom flap joined to the front panel; a back bottom flap joined to the back panel; a first side bottom flap joined to one of the opposing side panels; and a second side bottom flap joined to another of the opposing side panels. At least two adjacent bottom flaps are coupled together. The front bottom flap, back bottom flap, first side bottom flap and second side bottom flap are configured to form a bottom when the carton is erected. The carton includes a first extension extending from one of the bottom flaps and overlying the bottom and a first partition is joined to the first extension, wherein the first partition is configured to define a plurality of compartments within the interior when the carton is erected. The partition may be joined to the extension at a crease that enables folding, which is caused to occur during squaring up from the flat sleeve configuration.

Another aspect of the present disclosure relates to a carton blank including a front panel, a first side panel, a back panel and a second side panel, wherein the front panel and the first side panel are joined at a first crease, the first side panel and the back panel are joined at a second crease and the back panel and the second side panel are joined at a third crease. The carton blank includes a front bottom flap joined to the front panel at a front bottom flap crease; a back bottom flap joined to the back panel at a back bottom flap crease; a first side bottom flap joined to the first side panel at a first side bottom flap crease; and a second side bottom flap joined to the second side panel at a second side bottom flap crease. The carton blank further includes a first extension extending from one of the bottom flaps, wherein the first extension has an extension length and the bottom flap has a bottom length, wherein the extension length is less than the bottom length, the length being considered generally parallel to one or more of the bottom flap creases; and a first partition joined, preferably at a crease, to the first extension.

A further aspect of the present disclosure relates to a method of erecting an auto-bottom carton. The method includes forming a carton sleeve in a knock down flat condition, wherein the carton sleeve comprises at least three panels, at least two panel creases wherein each panel crease joins two of the at least three panels, a plurality of bottom flaps joined at a bottom flap crease to an associated panel wherein at least two adjacent bottom flaps are coupled, a first extension joined to one of the bottom flaps, and a first partition joined to the first extension. The method further includes coupling at least two adjacent bottom flaps and squaring the carton sleeve to define a carton interior, whereby the plurality of bottom flaps form a carton bottom, the first partition is drawn into the carton interior forming a plurality of compartments therein, and the first extension overlies the carton bottom. The method also includes restraining the squared carton sleeve to prevent the carton sleeve from assuming the knock down flat condition.

Following is a non-limiting list of reference numerals used in the drawings of the disclosure:

| Reference | Item |
|---|---|
| 100 | carton blank |
| 102 | front panel |
| 104 | first side panel |
| 106 | back panel |
| 108 | second side panel |
| 112 | first crease |
| 114 | second crease |
| 116 | third crease |
| 120 | front bottom flap |
| 121 | front side bottom flap clearance cutout |
| 122 | first bottom flap crease |
| 124 | first fixation tab |
| 126 | first fixation tab crease |
| 127 | third fixation tab crease |
| 128 | back bottom flap |
| 130 | back bottom flap crease |
| 132 | second fixation tab |
| 134 | second fixation tab crease |
| 135 | fourth fixation tab crease |
| 140 | first side bottom flap |
| 142 | first side bottom flap crease |
| 144 | first extension |
| 146 | first partition |
| 147 | first partition clearance cutout |
| 148 | first partition crease |
| 150 | second side bottom flap |
| 151 | second side bottom flap cutaway |
| | portion |
| 152 | second side bottom flap crease |
| 154 | second extension |
| 156 | second partition |
| 157 | second partition clearance cutout |
| 158 | second partition crease |
| 159 | additional cutout in second partition |
| 162 | fixation lap |
| 164 | fixation lap crease |
| 166 | first surface |
| 167 | second surface |
| 170 | closure flap |
| 172 | closure crease |
| 174 | closure flap tuck |
| 176 | tuck crease |
| 176a | scored portion |
| 176b | cut portion |
| 176c | cut portion |
| 180 | first top side flap |
| 181 | first top flap clearance cutout |
| 182 | first top side flap crease |
| 185 | second top flap clearance cutout |
| 184 | second top side flap |
| 186 | second top side flap crease |
| 187 | first cut line |
| 189 | second cut line |
| 194 | first locking feature |
| 196 | first notch |
| 198 | second locking feature |
| 200 | second notch |
| 202 | first flap edge |
| 204 | second flap edge |
| 210 | first foot |
| 212 | first foot crease |
| 214 | second foot |
| 216 | second foot crease |
| 236 | partition stabilizer |
| 238 | partition stabilizer crease |
| 300 | sleeve |
| 302 | interior |
| 304 | bottom |
| 306, 308 | plurality of compartments |
| 340 | distal portion of front bottom flap |
| 350 | distal portion of back bottom flap |
| L102 | length of front panel |
| L104 | length of first side panel |
| L106 | length of back panel |
| L108 | length of second side panel |
| L120 | front bottom flap length |
| L128 | back bottom flap length |
| L140 | first side bottom flap length |
| L144 | first extension length |
| L146 | first partition length |
| L150 | second side bottom flap length |
| L154 | second extension length |
| L156 | second partition length |
| L170 | closure flap length |
| H102 | front panel height |
| H104 | first side panel height |
| H106 | back panel height |
| H108 | second side panel height |
| H120a | first front bottom flap height |
| H120b | second front bottom flap height |
| H128a | first back bottom flap height |
| H128b | second back bottom flap height |
| H140 | first side bottom panel height |
| H144 | first extension height |
| H146 | first partition height |
| H150 | second side bottom panel height |
| H154 | second extension height |
| H156 | second partition height |
| H170a | first closure flap height |
| H170b, H170c | second closure flap height |
| H174 | closure flap tuck height |

What is claimed is:

1. A carton (100) comprising:
a front panel (102), a pair of opposing side panels (104, 108), and a back panel (106) opposing said front panel (102), wherein said front panel (102), said side panels (104, 108) and said back panel (106) form a sleeve (300), and said sleeve defines an interior (302);
a front bottom flap (120) joined to said front panel (102);
a back bottom flap (128) joined to said back panel (106);
a first side bottom flap (140) joined to one of said opposing side panels (104, 108);
a second side bottom flap (150) joined to another of said opposing side panels (104, 108);
wherein at least two adjacent bottom flaps (120, 128, 140, 150) are coupled and said front bottom flap (120), said back bottom flap (128), said first side bottom flap (140) and said second side bottom flap (150) are configured to form a bottom (304) when said carton is erected;
a first extension (144, 154) extending from one of said bottom flaps (140, 150) and overlying said bottom (304); and
a first partition (146, 156) joined to said first extension (144, 154), wherein said first partition (146, 156) is configured to define a plurality of compartments (306, 308) within said interior (302) when said carton is erected.

2. The carton of claim 1, wherein said first partition (146, 156) is joined to said first extension (144, 154) at a first partition crease (148, 158).

3. The carton of claim 1, further comprising a first fixation tab (124) extending from said front bottom flap (120), wherein said first fixation tab (124) is affixed to said first side bottom flap (140) in an overlapping manner coupling said front bottom flap (120) to said first side bottom flap (140); and a second fixation tab (132) extending from said back bottom flap (128), wherein said second fixation tab (132) is affixed to said second side bottom flap (150) in an overlapping manner coupling said back bottom flap (128) to said second side bottom flap (150).

4. The carton of claim 1, further comprising a first foot (210, 214) extending from said first partition (146, 156), wherein said first foot (210, 214) is configured to bend relative to said first partition (146, 156) such that when said carton is erected said first foot (210, 214) is substantially parallel to said bottom (304).

5. The carton of claim 1, further comprising a second extension (144, 154) extending from another one of said bottom flaps (140, 150) and located within said interior (302); and a second partition (146, 156) joined to said second extension (144, 154) and configured to bend relative to said second extension (144, 154).

6. The carton of claim 5, wherein said second partition (146, 156) defines at least one additional compartment within said interior (302) when said carton is erected.

7. The carton of claim 5, further comprising a second foot (210, 214) extending from said second partition (146, 156), wherein said second foot (210, 214) is configured to bend relative to said second partition (146, 156) such that when said carton is erected said second foot (210, 214) is substantially parallel to said bottom (304).

8. The carton of claim 1, further comprising a closure flap (170) joined to one of said panels (102, 104, 106, 108), wherein said closure flap (170) is configured to bend relative to said one of said panel (102, 104, 106, 108) and enclose said interior (302).

9. The carton of claim 1, wherein the length of said first extension (L144, L154) is less than the length of said first partition (L146, L156) and said length of said first extension (L144, L154) is less than the length of the bottom flap (L140, L150) from which said first extension (144, 154) extends, wherein the length is generally parallel to a bottom flap crease (122, 130, 142, 152) joining one of said panels (102, 104, 106, 108) to an associated bottom flap (120, 128, 140, 150).

10. The carton of claim 1, wherein both sides of said first extension (144, 154) are disposed within said interior (302).

11. A carton blank (100) comprising:
a front panel (102), a first side panel (104), a back panel (106) and a second side panel (108), wherein said front panel (102) and said first side panel (104) are joined at a first crease (112), said first side panel (104) and said back panel (106) are joined at a second crease (114) and said back panel (106) and said second side panel are joined at a third crease (116);
a front bottom flap (120) joined to said front panel (102) at a front bottom flap crease (122);
a back bottom flap (128) joined to said back panel (106) at a back bottom flap crease (130);
a first side bottom flap (140) joined to said first side panel (104) at a first side bottom flap crease (142);
a second side bottom flap (150) joined to said second side panel (106) at a second side bottom flap crease (152);
a first extension (144, 154) extending from said one of said bottom flaps (140, 150, 128, 120), wherein the length of said first extension (L144, L154) is less than the length of said bottom flap (L140, L150, L128, L120) from which said first extension extends, wherein length is generally parallel to at least one of said bottom flap creases (122, 132, 142, 152); and
a first partition (146, 156) joined to said first extension (144, 154).

12. The carton blank of claim 11, further comprising a first fixation tab (124, 132) extending from at least one of said bottom flaps (120, 140, 128, 150) and joined to said bottom flap (120, 140, 128, 150) at a first fixation tab crease (126, 134).

13. The carton blank of claim 11, wherein said first partition (146, 156) is joined to said first extension (144, 154) at a first partition crease (148, 158).

14. The carton blank of claim 11, wherein the length of said first partition (L146, L156) is greater than the length of said first extension (L144, L154).

15. The carton blank of claim 11, further comprising a first foot (210, 214) extending from said first partition (146, 156) and joined to said first partition (146, 156) at a first foot crease (212, 216).

16. The carton blank of claim 11, further comprising a second extension (144, 154) extending from another one of said bottom flaps (140, 150) and a second partition (146, 156) joined to said second extension (144, 154) at a second partition crease (148, 158).

17. The carton blank of claim 16, further comprising a second foot (210, 214) extending from said second partition (146, 156) and joined to said second partition (146, 156) at a second foot crease (112, 116).

18. The carton blank of claim 11, further comprising a fixation lap (162) joined to one of said panels (102, 104, 106, 108) at a fixation lap crease (164).

19. The carton blank of claim 11, further comprising a closure flap (170) joined to one of said panels (102, 104, 106, 108) at a closure crease (172).

20. The carton blank of claim 19, further comprising a flap tuck (174) joined to said closure flap (170) at a flap tuck crease (176).

21. The carton blank of claim 11, further comprising a top side flap (180, 184) joined to one of said panels (102, 104, 106, 108) at a top side crease (182, 186).

22. The carton blank of claim 11, wherein the length of said front panel (L102) and the length of said back panel (L106) are greater than the length of said first side panel (L104) and the length of said second side panel (L108).

23. The carton blank of claim 11, wherein said first extension (144, 154) is configured to overlie one of said bottom flaps (140, 150) when the carton blank is erected into a carton.

24. A method of erecting an auto-bottom carton, comprising:
forming a carton sleeve in a knock down flat condition, wherein said carton sleeve comprises
at least three panels (102, 104, 106, 108),
at least two panel creases (112, 114, 116) wherein each panel crease (112, 114, 116) joins two of said at least three panels (102, 104, 106, 108),
a plurality of bottom flaps (120, 128, 140, 150) joined at a bottom flap crease (122, 142, 130, 152) to an associated panel wherein at least two adjacent bottom flaps (120, 128, 140, 150) are coupled,
a first extension (144, 154) joined to one of said bottom flaps (120, 128, 140, 150), and a first partition (146, 156) joined to said first extension (144, 154);
coupling at least two adjacent bottom flaps (120, 128, 140, 150);
squaring said carton sleeve to define a carton interior (302), whereby said plurality of bottom flaps (120, 128, 140, 150) form a carton bottom (304), said first partition is drawn into said carton interior (302) forming a plurality of compartments (306, 308) therein, and said first extension (144, 154) overlies said carton bottom (304); and
restraining the squared carton sleeve to prevent said carton sleeve from assuming the knock down flat condition.

25. The method of claim 24, further comprising bending said first partition (146, 156) relative to said first extension (144, 154) at a first partition crease (148, 158) joining said first partition (146, 156) to said first extension (144, 154).

26. The method of claim 24, wherein restraining said squared carton sleeve comprises mating locking features (194, 198) formed in at least two of said plurality of bottom flaps (120, 128, 140, 150).

27. The method of claim 24, wherein coupling said at least two adjacent bottom flaps (120, 128, 140, 150) comprises affixing a first fixation tab (124, 132) extending from one of said at least two adjacent bottom flaps (120, 128, 140, 150) to the adjacent bottom flap (120, 128, 140, 150) in an overlapping manner.

28. The method of claim 24, wherein said carton further comprises at least four panels (102, 104, 106, 108) and at least three panel creases (112, 114, 116) wherein each of said panel creases (112, 114, 116) joins two of said at least four panels (102, 104, 106, 108).
